(19) United States
(12) Patent Application Publication
(10) Pub. No.: US 2016/0321892 A1
(43) Pub. Date: Nov. 3, 2016

(54) MONITORING SYSTEM AND METHOD FOR COMBINING DETECTOR AND CAMERA OUTPUTS

(71) Applicant: Honeywell International Inc., Morristown, NJ (US)

(72) Inventors: Manjunatha Divakara, Tumkur (IN); Balamurugan Ganesan, Bangalore (IN)

(21) Appl. No.: 14/699,116

(22) Filed: Apr. 29, 2015

(51) Int. Cl. G08B 13/196

(52) U.S. Cl. CPC G08B 13/19695; G08B 13/19645

(57) ABSTRACT

A regional monitoring system includes a plurality of condition detectors coupled to an alarm system control panel. At least one camera is coupled to the control panel. In response to a potential alarm indicating indicator from one of the detectors, the control panel obtains location information for the respective detector, and directs the field of view of the camera to include the location of the detector. An alarm condition can be determined in response to the images from the camera in combination with outputs from the respective detector.

### FIELD

The application pertains to regional monitoring systems which incorporate signals from different types of security devices. More particularly, it pertains to such systems and methods which respond to both signals from various types of sensors, or detectors, and camera images of the region where the sensors or detectors are located.

### BACKGROUND

Secured premises can be expected to include different zones like entry/exit, perimeter, and interior followers. Zones can exhibit different behaviors corresponding to an armed or disarmed state of a system control panel. Entry/exit zones are monitored by door contacts. Perimeter zones are monitored by window transmitters. Interior followers are monitored by motion detectors. Modern day secured premises mostly are often equipped with one or more cameras along with the different security sensors as mentioned above.

Despite the presence of installed monitoring systems, security related issues can still persist. There are various scenarios when the sensors are bypassed because they are not working properly and are in need of maintenance. This leaves the premises vulnerable to security attacks.

The sensors deployed at secured premises will sometimes cause false alarms due to environmental and external noisy situations. False alarms are annoying to end users of the premises. Hard coded configuration parameters like exit delays may not, at times, be sufficient. Currently they do not adapt to dynamic conditions. The video systems which are present with cameras operate independently and do not work in collaboration with installed intrusion sensors.

### BRIEF DESCRIPTION OF THE DRAWINGS

FIG. 1 is a block diagram illustrating aspects of a system in accordance herewith;

FIG. 2 is another block diagram illustrating additional aspects of the system of FIG. 1;

FIG. 3 is a flow diagram illustrating confirmatory alarm processing; and

FIG. 4 is a flow diagram which illustrates cross zone processing.

### DETAILED DESCRIPTION

While disclosed embodiments can take many different forms, specific embodiments thereof are shown in the drawings and will be described herein in detail with the understanding that the present disclosure is to be considered as an exemplification of the principles thereof as well as the best mode of practicing same, and is not intended to limit the application or claims to the specific embodiment illustrated.

In accordance with a disclosed embodiment, it is possible to map the spatial coordinates in an image captured by camera to the different response types like entry/exit, perimeter and interior follower. Thus it is possible to get the intrusion response type actions for the activities observed or analyzed through video analytics with-in the mapped spatial coordinates. In other words particular spatial coordinates in an image can act like a motion detector; or in other regions can act like a window transmitter.

In one aspect, it is possible to reduce false alarms by verifying an image within selected spatial coordinates with applied video analytics.

In yet another aspect, it is possible that configured parameters like exit delays may be dynamically modified by using the image analytics. A user's exit time through a door can be increased by detecting that the user is approaching the exit door slowly and needs extended exit delay time. This is an advantage made available by coordinating camera outputs with other types of detectors.

Further, when the zones are bypassed, the camera image captured in the mapped spatial coordinates can be used to provide the functionality of the bypassed zone. For example, if the window transmitter is bypassed then the spatial coordinates of the camera image can run the video analytics for the activity in the window region of the house or monitored region to provide the perimeter zone functionality.

Advantageously, in accordance herewith, it is possible to cross zone the intrusion sensors with the spatial coordinates of an image captured by the camera. The intrusion activity can be detected by intrusion sensors by verification with the analytics on the image in the respectively mapped spatial coordinates.

In summary, as discussed below, embodiments hereof provide for mapping the different spatial coordinates to different intrusion response types and other related uses.

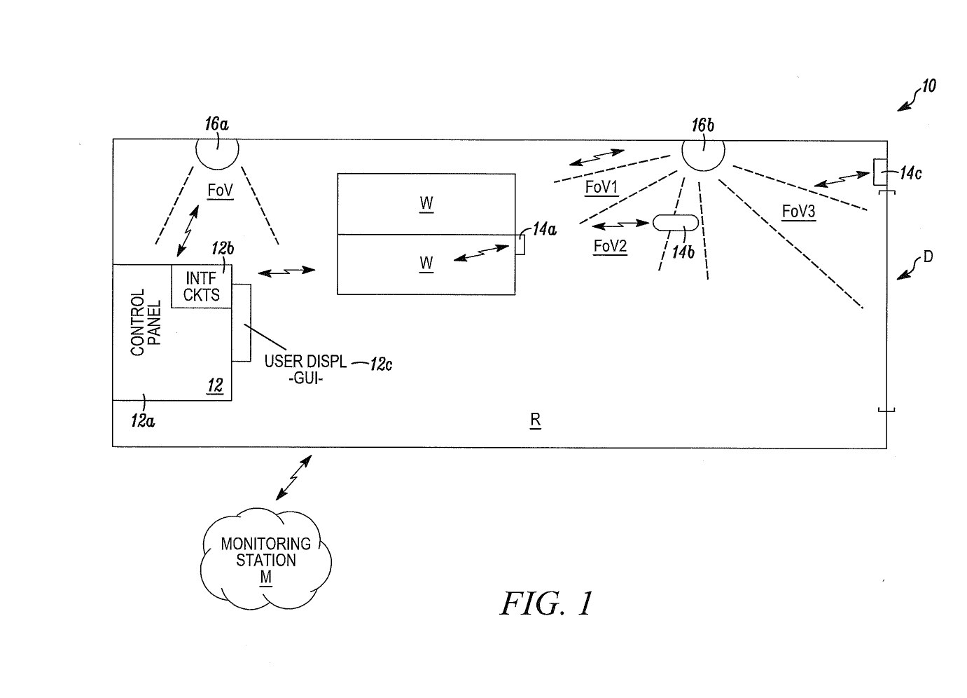

FIG. 1 illustrates a combination 10 in accordance with an embodiment hereof. In FIG. 1, a region R is being monitored by a security system which includes a control panel 12. The panel 12 includes control circuits 12a, interface circuits 12b coupled to the control circuits 12a, and a user interface which could be implemented as a graphical user interface 12c.

The control panel 12 communicates with a plurality of monitoring devices, or detectors such as window detector 14a, which could detect glass breakage. A motion sensor, such as a passive infrared detector 14b can detect motion through the adjacent region R. A door sensor 14c can respond to a door D being opened or closed.

One or more security cameras such as 16a, 16b can be installed in the region R, and coupled to the panel 12. The cameras, such as 16a can have a variable field-of-view, FOV. As illustrated with respect to camera 16b, fields-of-view FOV1, FOV2, FOV3 can be established by camera movement under the control of panel 12 as would be understood by those of skill in the art.

The panel 12 can be in wired or wireless communication with the various detectors 14i as well as the cameras 16i. As described below, a condition sensed by window W can cause the panel 12 to direct camera 16a to move its FOV so that the window W falls within that FOV. Similarly, the FOV of camera 16b can be moved to bring the interior movement detector 14b, or the door D into that FOV.

An optical determination can be made, in combination with detector outputs, at panel 12. The results can be forwarded to a monitoring station M.

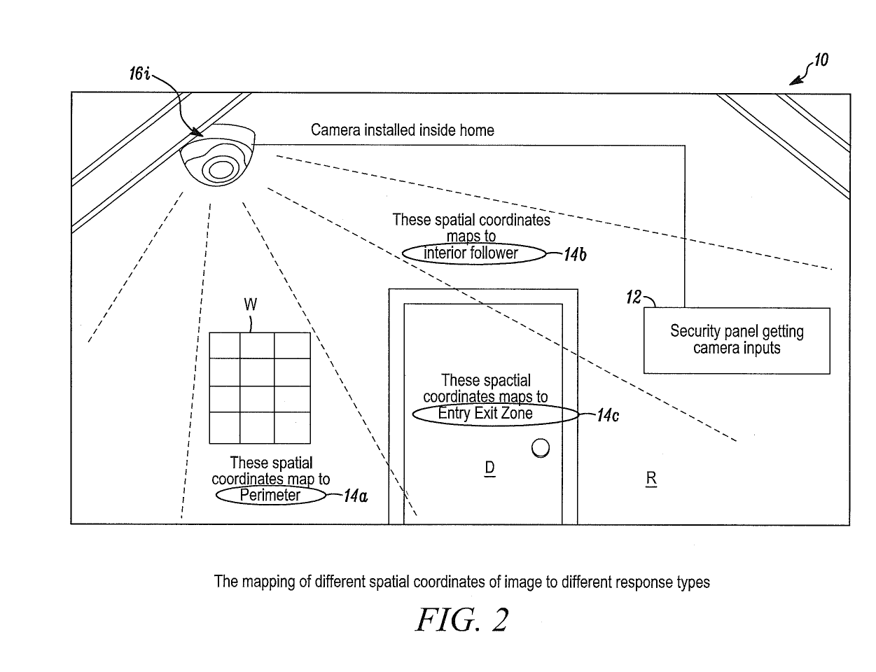

Relative to FIGS. 1, 2 different spatial coordinates can be assigned to different intrusion response types. The spatial coordinates of the image in the door can be mapped to an entry/exit response type by the control panel 12. Similarly, the coordinates of the window W can be mapped by the control panel 12 to the perimeter response type of action. The control panel 12, upon detection of any activity within these regions of interest found using the video analytics, could act, in conjunction with the respective window, motion or door detector, to trigger the respective intrusion actions.

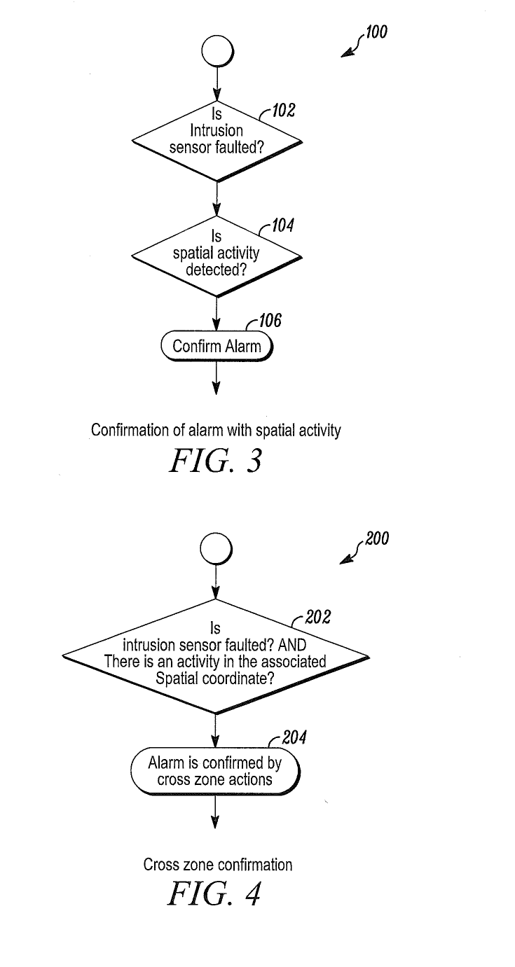

FIG. 3 is a diagram illustrating a process 100 of confirmation of an alarm with spatial activity from a selected camera. When the panel 12 detects a faulted sensor or detector (such as 14a, 14b, or 14c) as at 102 the FOV of a nearby camera, such as 16a, 16b can be directed toward the respective detector, as at 104. Where the respective camera couples appropriate spatial activity to the panel 12, an alarm condition can be confirmed, as at 106.

In another instance, an exit delay is adjustable such that, it would be sufficiently long for a user to exit the premises after arming the panel. The exit delay can be terminated after confirming that the user has exited the region R through the door D. The exit of the user can be confirmed by the activity within the spatial coordinates mapped for the entry exit response type area.

Sometimes the intrusion zones are bypassed and armed. The bypassing may be due to faulty sensors. In this instance, the camera spatial coordinates can work like a sensor which is bypassed. For example if the window transmitter is bypassed, the spatial coordinates associated with the window sensor can be monitored for the activities using the video analytics to work like a perimeter zone.

Finally, with respect to FIG. 4, in a process 200 the spatial coordinates can be used to implement cross zone confirmation for each of the intrusion detectors, or, sensors within the view of camera. The activities confirmed with camera view can trigger the alarms in the security system. As in FIG. 4, where one of the intrusion detectors, or sensors, has faulted, and there is a predetermined type of activity associated with the respective spatial coordinates, as at 202, the alarm can be confirmed by information from various types of detectors, or sensors as at 204.

As described, above, a regional monitoring system includes a plurality of condition detectors coupled to an alarm system control panel. At least one camera is coupled to the control panel. In response to a potential alarm indicating signal, or, indicator from one of the detectors, the control panel obtains location information for the respective detector, and directs the field of view of the camera to include the location of the detector. An alarm condition can be determined in response to the images from the camera in combination with outputs from the respective detector.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

Further, logic flows depicted in the figures do not require the particular order shown, or sequential order, to achieve desirable results. Other steps may be provided, or steps may be eliminated, from the described flows, and other components may be add to, or removed from the described embodiments.

1. A regional monitoring system comprising:
a plurality of zone monitoring detectors;
at least one camera; and
a regional control element which receives signals from the detector and the camera where, responsive to a condition sensed at a detector, at a predetermined location, the element evaluates signals from the location and provides at least one condition confirming indicator at a selected user device.

2. A monitoring system as in claim 1 wherein the detectors are selected from a class which includes at least position detectors, window detectors, and motion detectors.

3. A monitoring system as in claim 2 wherein the element correlates predetermined location information for each detector, and activates the camera to provide at least one image of the location specified by the coordinates.

4. A monitoring system as in claim 1 wherein feedback is provided to the element by images from the camera of the location of an active detector.

5. A monitoring system as in claim 1 wherein, responsive to a signal from the at least one detector, the element can retrieve detector coordinates and direct the camera's field of view to include the retrieved coordinates.

6. A monitoring system as in claim 5 wherein the camera can confirm the presence of an alarm condition prior to issuance of an alarm indicating output.

7. A monitoring system as in claim 3 wherein different locations are associated with different types of intrusion responses.

8. A monitoring system as in claim 7 wherein the types of responses include at least one of, an entry/exit response type, a perimeter response type, or, an alarm confirmation response type.

9. A monitoring system as in claim 1 which includes a plurality of cameras coupled to the control element.

10. A method comprising:
providing a plurality of alarm system detectors;
providing a camera;
responding to an alarm signal from a respective detector; and
receiving location information from the respective detector, and responsive thereto, obtaining an image via the camera of the location of the respective detector.

11. A method as in claim 10 including associating location information with each detector.

12. A method as in claim 10 wherein, responding to the image includes confirming the presence of a predetermined condition by using spatial activity in the image.

13. A method as in claim 10 which includes providing cross zone confirmation of the alarm signal.
